(19) United States
(12) Patent Application Publication
(10) Pub. No.: US 2002/0082035 A1
(43) Pub. Date: Jun. 27, 2002

(54) Communication method, radio AD-HOC network, communication terminal, and bluetooth terminal

(76) Inventors: Toru Aihara, Yokohama-shi (JP); Susumu Shimotono, Hadano-shi (JP); Akihiko Mizutani, Zushi-shi (JP)

Correspondence Address: Ronald L Drumheller, Esq., 94 Teakettle Spout Road, Mahopac, NY, 10541, US

(21) Appl. No.: 09/900,329

(22) Filed: Jul. 6, 2001

(30) Foreign Application Priority Data
Jun. 7, 2000 (JP) 2000-205724

(51) Int. Cl. H04Q 7/20

(52) U.S. Cl. 455/518; 455/519

(57) ABSTRACT

A network communication is performed automatically and in an optimal manner in radio ad-hoc communications. A communication terminal is configured to serve as one of a plurality of nodes composing a cluster as well as serve as a cluster head that allows communication with remaining nodes of cluster members and includes: a unit 11 for determining aptitude degree as cluster head that comprehends communication conditions with the cluster members; unit 12 for creating schedules for change of cluster head that creates schedule tables 15 to circulate the cluster members in order as a tentative cluster head; a unit 21 for monitoring aptitude degree of communication conditions that recognizes communication conditions with other nodes when the cluster member becomes the tentative cluster head; and a unit 26 for reconfiguring cluster that reconfigures the cluster based on the comprehended communication conditions and the recognized communication conditions.

### FIELD OF THE INVENTION

The present invention relates to a communication by a plurality of radio stations, and more particularly to a communication method for communicating by composing a cluster by a plurality of radio stations.

### RELATED ART

In recent years, due to miniaturization and weight saving of portable information terminals, information terminals are casually carried by many users. Accordingly, a lot of researches are being made for constructing a radio ad-hoc network as an on-demand communication in order to exchange information freely under a mobile environment. This radio ad-hoc network is directed, as one form of mobile computing, to provide communication means for receiving and sending data between temporarily gathering terminals in a condition where the distance and time are close, which is a network composed of a plurality of persons on the spot if necessary who have an information terminal.

On the other hand, the Bluetooth is rapidly attracting attentions, intending to provide a convenient service to mobile and business users, utilizing a short-haul radio technology that is incorporated in diversified apparatuses in the course of manufacture. The Bluetooth is based on a small and high-performance radio transceiver and is allocated 48 bit address complying with IEEE 802 standard and operates on the ISM free band of 2.45 GHz that is out of regulations. Also, its coverage is 10 m that is best suited for mobile and business users and its power consumption is only 0.3 mA in the standby mode, which extends the life of apparatuses that use a battery. The Bluetooth may be easily mounted in peripheral apparatuses such as a telephone, digital camera, printer, etc., and further is expected to be normally equipped into information terminals such as a notebook computer and a PDA (Personal Digital Assistance). In such a circumstance, a system that can communicate ad-hoc in a conference room by using a notebook computer or a PDA that is equipped with the Bluetooth, for example, is conceivable as an extremely natural applicable case.

However, a radio ad-hoc communication has some aspects that are fundamentally different from conventional cable networks and wireless networks that have recently come into practical use, in terms of configuration of channels and networks, which prevents popularization.

That is, when starting communication, a network must be configured first of all. In this respect, for a cable network, a network administrator prepared facilities in advance, such as laying of cables and terminals and installation of routers, thus a user simply needs to connect to the terminal in order to enter the network. Also, for a wireless network, a network administrator defined the service area and located fixed base stations, thus a user simply needs to access the base station within the service area in order to enter the network. On the contrary, there is no network administrator for the ad-hoc network, thus fellow users who gathered ad-hoc must configure the network in some way before they start communication. That is, fellow users must confer together to do the substantial wiring works. This is difficult to automatically achieve, besides accomplished wiring conditions are not optimal in most cases in view of the temporal restrictions.

Furthermore, it complicates the problems seriously that each radio station moves. Since each radio station moves at random in an ad-hoc network, optimization of the network configuration is needed regularly. Further, since what is immovable such as a base station can not be assumed, the optimization often results in changing the network topology greatly.

The wireless data communication by the Bluetooth, for example, employs the master-slave configuration. In the master-slave configuration, the master can connect to a plurality of slaves, whereas fellow slaves can not communicate. In the ad-hoc network under these constraints, it is a vital issue to select a cluster head. Since fellow slaves can not communicate, all communications are performed by means of communications between a master and slaves. As a result, if an inappropriate cluster head is selected, it affects the communication efficiency of the entire cluster.

In a typical ad-hoc network, it is often the case that fellow cluster members can communicate, so the central tasks of the cluster head are to manage the cluster and to maintain the channels. Therefore, an effect the cluster head has on the communication efficiency is not so much as the Bluetooth. In addition, even if an optimal cluster head has been selected, the topology is not necessarily maintained since each cluster member station and also the cluster head itself may move. For that reason, heretofore, the dominating idea is that it is enough to establish the connection in the meantime. Generally, due to an overhead that is necessary to synchronize the communication frequency and the timing of sending and receiving in order to select a cluster head, and further due to the hidden terminal issues specific to the radio transmission (for example, even if station A can communicate with stations B and C, the stations B and C can not communicate directly), the optimization of the cluster and the reconfiguration of the cluster were ineffective.

On the other hand, assuming the situation described above, where people get together in a conference room and communicate ad-hoc by exchanging files and messages among notebook computers they own, the optimization of the cluster head is vitally important. For example, people rarely move during the meeting and even if they move, they may move at such a slow speed as walking. On the other hand, there are comings and goings of participants in the meeting, wherein the number of radio stations increases and decreases. Even if no radio station moves, the optimal cluster head may change due to such increase and decrease of the number of radio stations, therefore, the dynamic reconfiguration of the cluster is necessary to maintain the communication efficiency. However, it takes time to reconfigure the cluster, thus an issue of overhead occurs which interrupts communications during the reconfiguration. In addition, as a cluster that is currently established will be broken up and a new cluster will be reconfigured, it is a big problem that not all radio stations are assured to be able to move into a new cluster.

It is also conceivable that participants might change the cluster head by manual operations after consultation, depending on comings and goings of people. However, people can not easily determine which radio station is the optimal cluster head. That is, the error rate of the wireless communication is affected by invisible obstacles and the performance of individual radio stations, so that a close distance between radio stations is not necessarily advantageous for communication. As a result, it is necessary to communicate actually and measure error rates in order to comprehend the communication conditions, so that it is not practical to change the cluster head by manual operations.

On the other hand, the Bluetooth needs a process called Inquiry, which is necessary to search for radio stations at the beginning of the communication between the master and the slaves, and a process called Page that takes time to connect the slaves to the master. According to the specifications, it requires a minimum of 10.24 sec of consecutive transmission of radio waves using a standard process in order to perform the Inquiry. Also, there is needed for Page an average of 1.5 sec per device to establish connections with devices that were found as a result of the Inquiry. Therefore, it takes about 20 sec to reconfigure the cluster even in a standard case without interference.

### SUMMARY OF THE INVENTION

The present invention is construed in view of these technical problems, therefore, an object of the present invention is to perform a network communication automatically and in an optimal manner in radio ad-hoc communications.

It is another object of the invention to detect the condition of an inappropriate cluster head and to re-select a better cluster head.

It is a further object of the invention to optimize the network configuration immediately after the configuration of the network or when a radio station with an extremely high error rate occurs.

In view of these objects, the present invention causes each radio station in the cluster to function as a tentative cluster head in order according to a predetermined time and period, then to acquire the receiving levels (the radio wave conditions of communication) from tentative cluster members configured corresponding to the respective tentative cluster head, and to compare them with the current radio wave condition. If the improvement is achieved, the cluster head is changed. That is, the present invention provides a communication method for a group communication in a radio ad-hoc network of the master-slave configuration, wherein direct inter-slave communications are impossible, for example, the method forming a predetermined cluster among a plurality of radio stations and selecting a cluster head managing the cluster, comprising the steps of: operating each one of the radio stations belonging to the cluster as a tentative cluster head; determIning the communication efficiency when the radio station becomes the tentative cluster head; and selecting a cluster head in the cluster among the radio stations composing the cluster based on the determined communication efficiency.

The method may further comprise the steps of: generating a schedule that determines an operation for circulating the radio stations as a tentative cluster head and an operation for the rest of each radio station composing the cluster to try to connect to each tentative cluster head; and operating the radio stations composing the cluster synchronously based on the generated schedule, wherein time needed for reconfiguring the cluster is advantageously reduced compared with when reconfiguring the cluster asynchronously.

The method may further comprise the steps of: determining an operation to return to an original cluster configuration after operating as the tentative cluster head and a recovery operation when being unable to return to the original cluster configuration as a recovery schedule in advance; and operating the radio stations composing the cluster synchronously based on the recovery schedule, wherein even if an error were to occur in the course of change of the cluster head, it is possible to take countermeasures based on the prior schedule.

In another aspect of the invention, there is provided a radio ad-hoc network composing a cluster that is composed of a node of a cluster head and one or more nodes of cluster members, wherein the node of the cluster head comprehends its own communication conditions with the nodes of the cluster members and generates a schedule for change of the cluster head based on the communication conditions and distributes the schedule to the nodes of the cluster members; and the nodes of the cluster members comprehend their own communication conditions with the nodes composing the cluster based on the distributed schedule and send the communication conditions to the node of the cluster head.

The node of the cluster head may determine whether or not to delegate its authority as a cluster head based on the communication conditions sent from the nodes of cluster members; and if affirmative, try to delegate its authority to appropriate nodes, wherein if the improvement effect is small for a work load for reconfiguring the cluster, it is possible to select the optimal situation depending on the condition of the cluster.

Further, the node of the cluster head may determine the time to return to an original cluster configuration where it continues to serve as a cluster head when failing to delegate its authority to the appropriate nodes, wherein an appropriate recovery is possible even if an error occurs in the course of change of the cluster head.

In a still further aspect of the invention, there is provided a radio ad-hoc network composing a cluster that is composed of a node of a cluster head and one or more nodes of cluster members, wherein the cluster head distributes a schedule that determines a circulation operation of a tentative cluster head on the cluster members that compose the cluster; and the cluster members comprehend as a tentative cluster head their communication conditions with other nodes based on the distributed schedule and sends the communication conditions to the cluster head, wherein the cluster members can become a new cluster head based on the delegation of authority from the cluster head.

The cluster head may distribute the schedule that determines the circulation operation immediately after configuring the cluster or when a node with a high error rate is detected, wherein necessary works can be smoothly performed when the reconfiguration of the cluster is needed.

In a yet further aspect of the invention, there is provided a communication terminal that can be configured as one of a plurality of nodes composing a cluster as well as serve as a cluster head that allows communication with remaining nodes of cluster members, comprising: means for comprehending communication conditions with the cluster members; means for recognizing communication conditions with other nodes when the cluster member becomes a tentative cluster head; and means for determining the delegation of cluster head to a specific node based on the comprehended communication conditions and the recognized communication conditions.

The means for comprehending communication conditions may comprehend the communication conditions by sending test data to each cluster member and detecting a packet error rate.

The communication terminal may further comprise: means for creating a schedule for circulating the cluster members in order as a tentative cluster head; and means for distributing the created schedule to the cluster members. The schedule determines, for example, time for circulating a tentative cluster head among nodes to search for an appropriate cluster head candidate; time for each node to try to connect to the tentative cluster head; and a period for which the reconnection is to be repeated if the tried connection failed.

The means for creating a schedule may create the schedule when the means for comprehending communication conditions determines that there is a trouble with the communication conditions.

In a further aspect of the invention, there is provided a communication terminal that can be configured as one of a plurality of nodes composing a cluster as well as serve as a cluster member that allows communication with other nodes of cluster head, comprising: means for receiving a circulation schedule to determine an aptitude degree as a cluster head from the cluster head; means for comprehending communication conditions with other nodes composing the cluster based on the received circulation schedule; and means for sending the comprehended communication conditions to the cluster head.

In a further aspect of the invention, there is provided a Bluetooth terminal that can be configured as one of a plurality of radio stations composing a piconet as well as manage a plurality of slaves as a master, comprising: means for comprehending communication conditions with the plurality of slaves; and means for delegating authority as a master to a predetermined slave composing the piconet to reconfigure the piconet if it is determined to be inappropriate as a master from the comprehended communication conditions.

The Bluetooth terminal may further comprise means for creating a schedule for circulating the plurality of slaves composing the piconet in order as a tentative master; and means for distributing the created schedule to the plurality of slaves, wherein the time needed for reconfiguring the piconet, i.e., the cluster is dramatically reduced and consequently the reconfiguration of the piconet becomes possible that is now substantially difficult.

The Bluetooth terminal may still further comprise, on the assumption that the communication efficiency of the entire piconet is directly affected when an inappropriate master is selected, means for receiving communication conditions with other radio stations when circulating a plurality of slaves as a tentative master; and means for determining to delegate authority as a master to the predetermined slave based on the received communication conditions, thereby delegating authority to an optimal slave depending on the communication conditions.

### BRIEF DESCRIPTION OF THE DRAWINGS

FIG. 1 is a diagram illustrating optimization of a cluster configuration by changing the cluster head according to the embodiment of the present invention.

FIG. 2 is a diagram showing an example of radio wave conditions of communication at each node.

FIGS. 3(a) and (b) shows an example when determining an aptitude degree by the throughput.

FIG. 4 is a diagram illustrating the configuration of an information terminal device (node) according to the embodiment of the present invention.

FIG. 5 is a flowchart illustrating the flow of optimization processing of the cluster according to the embodiment of the present invention.

### DESCRIPTION OF THE PREFERRED EMBODIMENT

Now the present invention will be described in reference to the attached drawings.

Before describing a concrete configuration of each information terminal device (node) that composes a cluster, we describe a cluster configuration where the present invention is applied to establish communications.

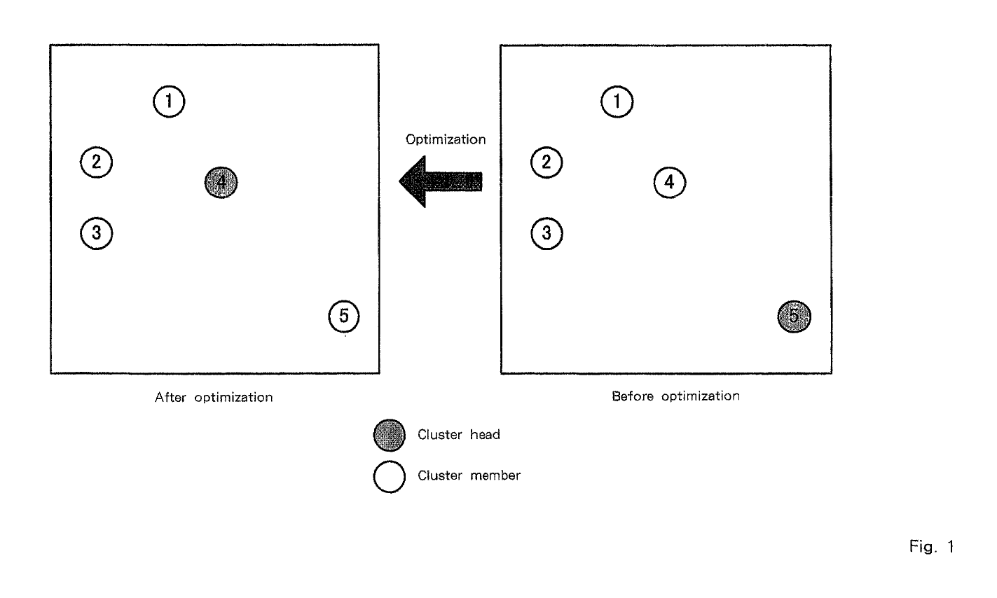

FIG. 1 is a diagram illustrating optimization of a cluster configuration by changing the cluster head according to the embodiment of the present invention. \mathring{1} to \mathring{5} shown in FIG. 1 are nodes (information terminals) composing a cluster, wherein the right diagram shows a cluster configuration before optimization, while the left diagram shows a cluster configuration after optimization. Before optimization, the node \mathring{5} is the cluster head and others are cluster members. A central work of the cluster head is to manage the cluster and to maintain channels.

In the right diagram of FIG. 1, i.e., before optimization, assuming that the node \mathring{5} of the cluster head detects the abnormality of communication conditions with the node \mathring{2}. Then, the node \mathring{5} causes nodes \mathring{1}, \mathring{2}, \mathring{3} and \mathring{4} to be a tentative cluster head in order, and investigates the radio wave conditions of communication between itself and all tentative cluster members.

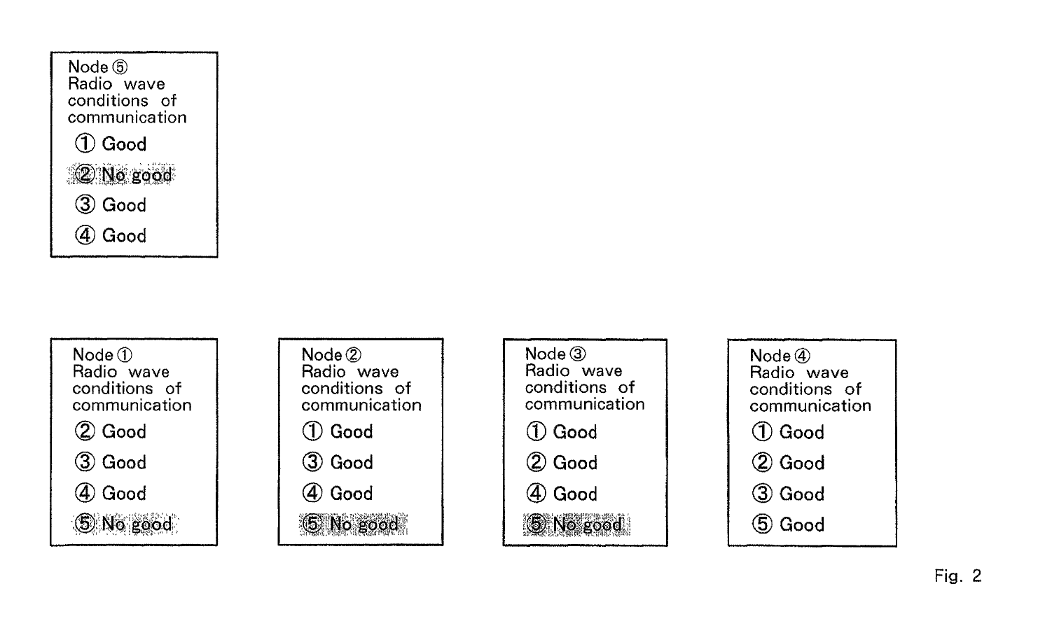

FIG. 2 is a diagram showing an example of radio wave conditions of communication at each node, wherein the communication conditions are shown when each node composing the cluster becomes the cluster head in order. As shown in FIG. 2, as for node 5, the communication condition with node 2 is no good, while the communication conditions with other cluster members are good. In an example shown in FIG. 2, the communication condition with each cluster member is all good when a node \mathring{4} becomes the cluster head.

A cluster head can regularly calculate the communication conditions by monitoring interactions of regular communication packets. On the other hand, a tentative cluster head can measure the communication conditions by sending a packet of the basic unit in sequence to its tentative cluster members. In case of Bluetooth, to-and-fro test of one packet is possible per 1.25 ms, therefore, for up to seven slaves, statistics of 100 packets are taken per slave during one second of observation. If the number of slave nodes that belongs to the piconet is small, the observation can be performed in less time.

Thereafter, the node \mathring{5} becomes the cluster head again, and compares the radio wave condtions of communication when serving itself as a cluster head with the radio wave conditions of communication when other nodes \mathring{1}, \mathring{2}, \mathring{3} and \mathring{4} are a tentative cluster head, thereby determining that the node \mathring{4} is more appropriate. This determination changes the cluster head from node \mathring{5} to node \mathring{4}, thereby resulting in the cluster configuration after optimization shown in the left diagram of FIG. 1. In this left diagram, the node \mathring{4} becomes the cluster head while the node \mathring{5} changes to a cluster member, thereby allowing a more efficient communication.

As an algorithm for change of a cluster head, assuming that the radio field intensity Is in inverse proportion to the third power of the distance, for example. Thus, assuming that the radio field intensity is 1 when the distance is 1, the radio field intensity is 0.008 when the distance is 5, which corresponds to the limit for enabling communication. Accordingly, it is possible to select a master head (Cluster head) such that nodes exist within distance of 3 (i.e., the radio field intensity is greater than 0.0370). Also, the conditions for change of a cluster head may be, for example, that a node exists whose distance is greater than or equal to 4 (i.e., the radio field intensity is less than 0.0156, which means the link is likely to fail), or that a node exists whose distance is greater than or equal to 3 (i.e., the radio field intensity is less than 0.0370) and the differences at all nodes are within five times (i.e., the cluster head locates at the end).

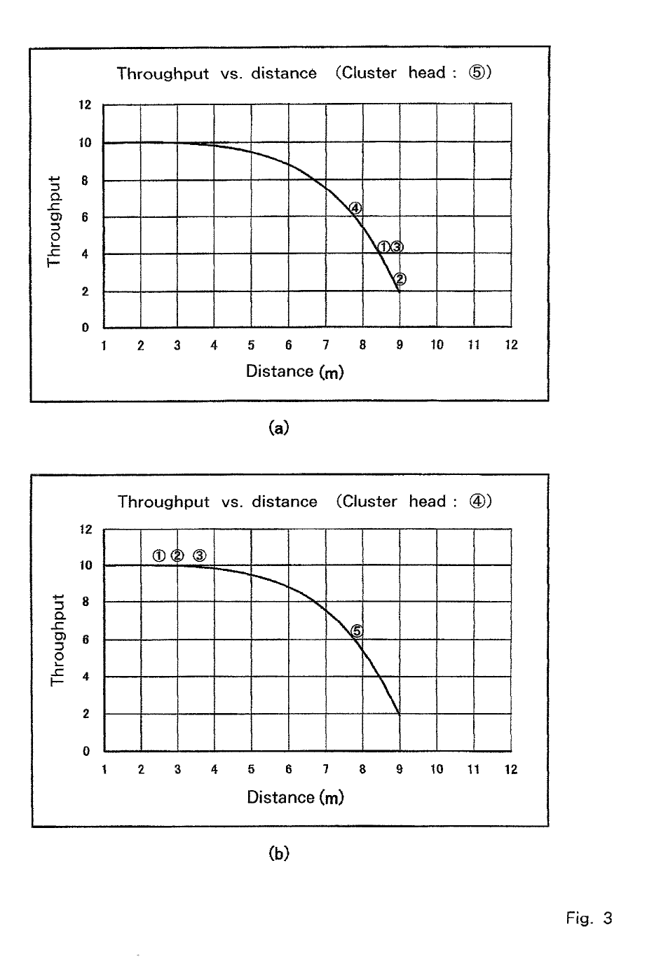

FIGS. 3(a) and (b) shows an example when determining an aptitude degree by the throughput. Note that the throughput is an amount of data that can be transmitted within a given time, wherein FIG. 3(a) shows before optimization when the cluster head is node \mathring{5}, while FIG. 3(b) shows after optimization when the cluster head is changed to node \mathring{4}. In each drawing, the horizontal axis shows a distance from the cluster head, while the vertical axis shows the throughput. Before optimization shown in FIG. 3(a), the distance of each cluster member from the cluster head (node \mathring{5}) is far, thus the throughput level is low. On the other hand, after optimization shown in FIG. 3(b), though the distance from the cluster head (node \mathring{4}) to the node \mathring{5} is far, the distance from other cluster members is short, thus the throughput is greatly improved.

As for the Bluetooth, the piconet corresponds to the cluster, the master corresponds to the cluster head, and the slaves correspond to the cluster members in the embodiments of the present invention. For the Bluetooth, the link manager protocol provides for commands LMP_incr_power_req and LMP_decr_power_req that increase and decrease the opponent's transmission output, which substantially performs AGC (automatic gain control) to obtain a proper receiving level in most devices. However, there is a case where despite the master requires the increase of the output (LMP_incr_power_req) due to the bad condition, the slave replies such that it can not increase the output level any more (LMP_max_power). Usually, in such a case, despite the opponent's slave also requires to increase the output level (LMP_incr_power_req), the master can not do so (LMP_max_power). In this case, the master is to be changed to obtain the piconet configuration that does not need a maximum output level.

An asymmetric case is also conceivable where despite the receiving level from the slaves is normal at the master, many slaves determine the receiving level is inadequate. This would occur when devices with different maximum output levels compose the piconet. In such a case, this device Is likely to be inappropriate for the master, thus the master should be changed to try a more adequate piconet configuration. As for the implementation of the Bluetooth, the steps and control of the output level are different depending on each manufacturer, thus no interface is provided for informing the output level, as a result, what is possible is to inform that the upper or lower limit has already been reached when trying to increase or decrease the output level.

When applying the present invention to the Bluetooth, it is possible to assure the communication conditions and reduce power consumption by reconfiguring the piconet. Also, as the Bluetooth can send multi-slot packets without FEC (forward error correction) during the good communication conditions, a maximum of 723.2 kbps (DH5 packet) of communication is possible (when converting to the point-to-point communication), however, when the communication conditions get worse, the single slot packet is to be transmitted accompanying the FEC, thus the performance degrades to a maximum of 108.8 kbps (with ⅔ FEC, DM1 packet), i.e., about 15% of the maximum rate. Assuring the good communication conditions according to the Dresent invention, the throughput can be improved. Though the Bluetooth can know the condition of the particular link using commands Get_Link_Quality and Read_RSSI on the HCI (host controller interface) provided as an API, each proper range differs depending on the implementation of the host controller of the Bluetooth, thus the specifications of each manufacturer should be referred to.

Next, the present invention will be described in terms of the configuration of an information terminal device composing the cluster.

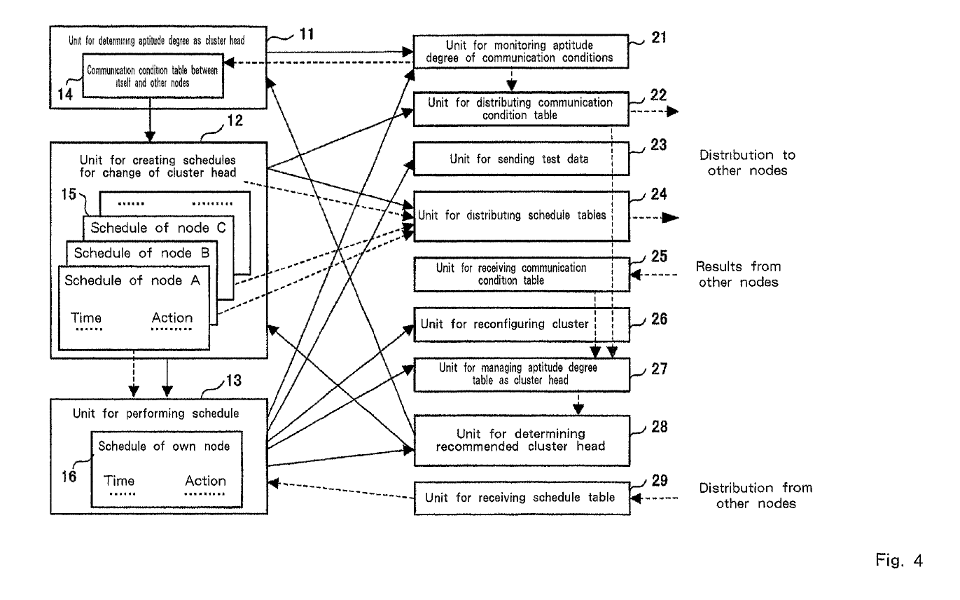

FIG. 4 is a diagram illustrating the configuration of an information terminal device (node) according to the embodiment of the present invention. The control devices include a unit 11 for determining aptitude degree as cluster head, a unit 12 for creating schedules for change of cluster head, and a unit 13 for performing its own schedule. In addition, the function devices include a unit 21 for monitoring aptitude degree of communication conditions, a unit 22 for distributing communication condition table, a unit 23 for sending test data, a unit 24 for distributing schedule tables, a unit 25 for receiving communication condition table, a unit 26 for reconfiguring cluster, a unit 27 for managing aptitude degree table as cluster head, a unit 28 for determining recommended cluster head, and a unit 29 for receiving schedule table. In FIG. 4, the solid line shows control relations, while the dotted lines show the flow of data.

The unit 11 for determining aptitude degree as cluster head provides for a communication condition table 14 that comprehends the radio wave conditions of communication between its own node and other nodes in the cluster shown in FIG. 2, and operates when it becomes the cluster head to determine whether or not to try to change the cluster head. The unit 12 for creating schedules for change of cluster head maintains a schedule table 15 for each node in the cluster, and creates a schedule indicating when and what to do for each node such that each node can synchronize upon change of the cluster head. The unit 13 for performing schedule performs a necessary function according to a schedule table 16 of own node.

The unit 21 for monitoring aptitude degree of communication conditions monitors communication conditions between the cluster head and cluster members and collects statistics information such as an error rate (e.g., creates communication condition table 14). The created communication condition table 14 is sent to the unit 11 for determining aptitude degree as cluster head. The unit 22 for distributing communication condition table distributes a communication condition table 14 created by the unit 21 to other nodes. The unit 23 for sending test data sends test data to each tentative cluster member when it becomes a tentative cluster head. The unit 24 for distributing schedule tables sends schedule tables 15 to other nodes. The unit 25 for receiving communication condition table receives the communication condition table 14. The unit 26 for reconfiguring cluster performs Page Scan and Page or the like to change the cluster configuration. The unit 27 for managing aptitude degree table as cluster head stores the results that were measured by the unit 21 for monitoring aptitude degree of communication conditions in each node. Essentially, it is enough that only the original cluster head manages these results, however, since it is not guaranteed to return to the original cluster after circulating the tentative cluster heads once, the results may be stored in all nodes by way of precaution. The unit 28 for determining recommended cluster head arranges the communication condition tables 14 when each node is made to be a cluster head, evaluates and orders the communication condition tables 14. The unit 29 for receiving schedule table receives a schedule table from other nodes.

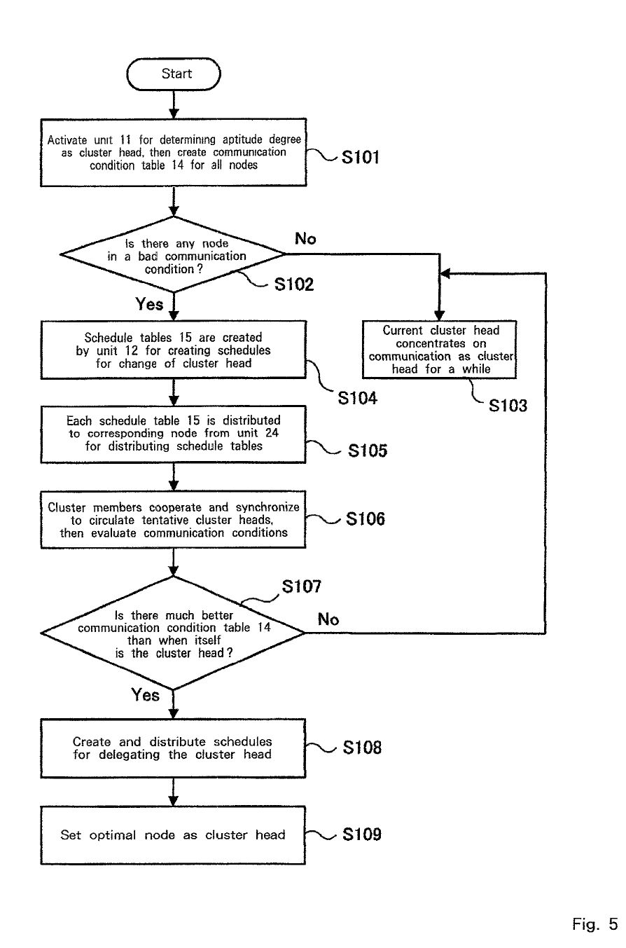

FIG. 5 is a flowchart illustrating the flow of optimization processing of the cluster according to the embodiment of the present invention. First, in the cluster head, the unit 11 for determining aptitude degree as cluster head is activated, then the communication conditions with all cluster members are comprehended by the unit 21 for monitoring aptitude degree of communication conditions to create the communication condition table 14 (step 101). Then, it is determined whether there is a node in a bad communication condition based on this communication condition table 14 (step 102). For example, the cluster head determines whether it is eligible as a cluster head by recording a packet error rate for each cluster member and calculating an average of error rates of the entire cluster and a standard deviation, for example, from these records. If only the error rates for some specific cluster members are high or the error rates for all cluster members are high, that cluster head may be ineligible. If it is determined that there is no bad communication condition in step 102, that is, the cluster is operating normally, the cluster head needs not be changed, so the current cluster head concentrates on the communication as a cluster head for a while (step 103). The unit 11 for determining aptitude degree as cluster head updates the communication condition table 14, based on information from the unit 21 for monitoring aptitude degree of communication conditions, which always monitors communication conditions with each node. If there is no bad communication condition, nothing is performed in other nodes serving as a cluster member.

If it is determined that there is any bad communication condition in step 102, that is, if it is detected that a communication condition with some node is not sound, a determination is made to try to change the cluster head. In this change of the cluster head, each node in the cluster is made to be a tentative cluster head, during which a communication condition table 14 is created. Thereafter, the results are compiled to determine a befitting cluster head, whereby the cluster head is changed if necessary.

Upon this change of the cluster head, the unit 12 for creating schedule for change of cluster head creates the schedule table 15 indicating when and what to do for each node (step 104). That is, the schedule table 15 is created which is a cluster head circulation schedule for evaluating the tentative cluster head. Since selection of a befitting cluster head accompanies a change of the cluster head at least temporarily, it is necessary to create a schedule table 15 for each cluster member in advance indicating when to change the cluster head, in order to reduce the overhead involved in this change. Creating these schedule tables 15 are based on the premise that there is no time mismatch between nodes of the cluster. In general, cluster members are synchronized with a cluster head. For example, for the Bluetooth, all nodes are in synchronization with a clock of the master, thus no time mismatch occurs. Upon creating the schedule tables 15, the procedure for circulating the tentative cluster head and the procedure for recovering to the original cluster head are determined, in each of which the role of each node is described with respect to time.

Next, the schedule table 15 is distributed to each node from the unit 24 for distributing schedule table utilizing the current cluster configuration (step 105). At the same time, the inconvenient communication condition table 14 for the cluster head is also distributed to all cluster members in view of later needs. The cluster head stores its own schedule table 15 in the unit 13 for performing schedule as a schedule table 16 of own node, while the cluster member stores its own schedule table 15 sent from the cluster head in the unit 13 as a schedule table 16 of own node.

Assuming that the cluster is composed of nodes A to F and the current cluster head is node A (cluster head A), and there is inconvenience in communication with node D. In this case, communication conditions are evaluated by circulating a tentative cluster head like A→B→C→E→F→D. Further, it is typically assumed to recover to the current cluster head A, however, in view of an unrecoverable case such as the node A moves out of range, it is preferable to order the nodes to specify how to recover the cluster (for example A→B→C→E→F→D).

For example, assuming to circulate tentative masters for 15 seconds each after 5 seconds in the following order, i.e., node B (5 to 20 sec) , node C (20 to 35 sec), node E (35 to 50 sec), node F (50 to 65 sec) and node D (65 to 80 sec), thereafter (i.e., after 80 sec), returning to the original cluster configuration where node A is the cluster head. Unfortunately, if being unable to return to the original configuration, each cluster member tries to recover the cluster making itself a cluster head in order. For example, if node B could not return to the cluster no later than 90 seconds where node A is the cluster head, node B tries to be the cluster head for recovery 90 seconds later, and if node C could not return to the clusters no later than 100 seconds where node A or B is the cluster head, node C tries to be the cluster head for recovery 100 seconds later, likewise, nodes E, F and D try to recover the cluster at 110, 120 and 130 seconds later respectively by treating other members as a cluster member. That is, according to the schedule table 15 of the original cluster head A, node A tries to become a member of the tentative cluster head by activating the Page Scan consecutively at 5, 20, 35, 50 and 65 seconds later, then 80 seconds later, node A performs the Page sequentially on the original cluster members as a cluster head to recover the original cluster configuration. On the other hand, according to the schedule table 15 of the original cluster member B, the Page is to be performed to all cluster members A, C, D, E and F at 5 second later to compose a tentative cluster, then the communication conditions are tested and this tentative cluster is broken up no later than 15 seconds, thereafter, the Page Scan is activated consecutively at 20, 35, 50 and 65 seconds later to become a tentative cluster member of the other tentative cluster head, further the Page Scan is performed 80 seconds later again to return to the original cluster configuration where node A is the cluster head. If the original cluster configuration where node A is the cluster head dose not be recovered no later than 90 seconds, the Page is activated to make itself a cluster head and try the cluster recovery.

At this time, the cluster member receives the schedule table 15 at the unit 29 for receiving schedule table of each node, which is set to the unit 13 for performing schedule. Also, the communication condition table 14 in the current cluster head (e.g., node A) is transmitted by way of precaution, which is stored in the unit 27 for managing aptitude degree table as cluster head in preparation for comparison after the circulation of the tentative cluster heads.

Next, the cluster members cooperate and synchronize according to their own schedule tables 15 to circulate the tentative cluster heads, then evaluate the communication conditions (step 106). During this circulation period, the original cluster head (node A) operates as a cluster member.

The circulation of the tentative cluster heads is to perform the Page Scan according to the schedule of the node A and change the tentative cluster heads in order. During this time, the unit 26 for reconfiguring cluster performs the Page Scan and the Page to change the cluster configuration. When being able to connect to respective tentative clusters, the communication condition table 14 at that time is sent to node A from the tentative cluster head and stored in the unit 27 for managing aptitude degree table as cluster head. When being unable to connect to the tentative cluster, the communication condition table is to be received from the unit 27 of another cluster head when connecting to that another cluster head later. Each node that operates as a cluster head in the tentative cluster composes the tentative cluster by activating the unit 26 for reconfiguring cluster, sends test data to each cluster member using the unit 23 for sending test data, and creates the communication condition table 14 in the unit 21 for monitoring aptitude degree of communication conditions, which is a table of transmission and reception conditions of the test data. The created communication condition table 14 is notified to each cluster member by the unit 22 for distributing communication condition table as well as stored in its own unit 27 for managing aptitude degree table as cluster head.

Next, node A corresponding to the original cluster head determines whether there is a much better communication condition table 14 than when itself is the cluster head (step 107). That is, the communication condition tables 14 of nodes A, B, C . . . , F that have been collected by now are transferred to the unit 28 for determining recommended cluster head from the unit 27 for managing aptitude degree tables as cluster head, in order to compare the improved effects. If it is determined that there is no better communication condition table 14, the original cluster configuration is recovered and maintained intact, wherein the current cluster head concentrates on the communication as a cluster head for a while (step 103). It is noted that despite the unit 27 for managing aptitude degree table as cluster head tries to change the cluster head when the same inconvenience (e.g., communication condition with node D is unsound) occurs, it may be rejected again. Therefore, this inconvenience may be tolerated until any other inconvenience occurs, or until this inconvenience gets worse, or until considerable time elapses, etc.

Next, in step 107, if there is much better communication condition table 14, the cluster head is changed after recovering the original cluster configuration. For example, as a result of the comparison, node C is found to be better and the authority is delegated to the cluster head C. In this case, the current cluster head, i.e., node A creates and distributes a schedule for delegating the cluster head (step 108). That is, as with the case of circulating the tentative cluster heads, the unit 12 for creating schedule for change of cluster head in node A creates the schedule tables 15 that is to be performed in each node, then each schedule table 15 is delivered to each cluster member by the unit 24 for distributing schedule tables, while its own schedule table 15 is passed to its own unit 13 for performing schedule as a schedule table 16 of own node.

If the cluster head is to be changed at this time, it is necessary to order all nodes as a final cluster head in the order of C, A, B, F and D, for example, to change the cluster head efficiently and smoothly keeping the synchronization. Therefore, according to the embodiment of the present invention, the order of nodes that are appropriate as the cluster head is notified to the unit 12 for creating schedules for change of cluster head.

More specifically, assuming the aptitude degree as a cluster head is in the order of C, A, B, E, F and D according to the scheduled circulation of tentative cluster head so far, each node is made the cluster head every 10 seconds, while the remaining nodes are incorporated into the cluster. For example, node C performs the Page 10 seconds later to try to incorporate each node to compose the cluster. Node A performs the Page Scan 10 seconds later to try to be incorporated into node C. If failed, it performs the Page itself 20 seconds later to try to incorporate other nodes in sequence to compose the cluster. Node B performs the Page Scan 10 or 20 seconds later to try to be incorporated into node C or A, then if failed, it performs the Page itself 30 seconds later to try to incorporate other nodes in sequence to compose the cluster. Likewise, nodes E, F, D performs in the similar manner according to their schedule tables 15.

Each cluster member receives the schedule table 15 sent from the current cluster head and sets it to its own unit 13 for performing schedule. The unit 13 changes the cluster configuration utilizing the unit 26 for reconfiguring cluster and performs the schedule until the cluster is configured successfully. In this way, an optimal node is set as a cluster head (step 109).

According to the above-mentioned flow, a node that is determined to be most efficient is selected as a cluster head, however, the case is conceivable where it is impossible to return to the original cluster configuration that uses the current cluster head, upon going to step 103. For example, such a case occurs when the original cluster head, i.e., node A does not operate due to power-off or movement, etc. In this case, the cluster is recovered in the form similar to the original cluster, by ordering the cluster members in advance and registering the time and period to become the cluster head for recovery and the time and period to become the cluster member of the cluster head for a specific recovery. That is, like the aforementioned circulation of the tentative cluster heads, the cluster is changed in the order of B, C, . . . , for example, according to the schedule tables 15 for change of cluster head in the unit 12 for creating schedules for change of cluster head. According to this configuration, even if the error occurs in the cluster configuration, the operation is performed successfully.

In the embodiment of the present invention, it has been described that the adaptability test as a cluster head is performed on all cluster members, and that all cluster members may become the cluster head for recovery, however, several cluster members may be removed depending on the capability and past history. By removing several cluster members, the efficiency may improve.

As stated above, according to the present invention, the time for reconfiguring the cluster is reduced by distributing the information about radio stations (nodes) to each radio station before reconfiguration and reducing the work necessary to search for radio stations. That is, according to the present invention, the procedure for temporarily or finally changing the cluster head, and a recovery method if an error were to occur during a change of the cluster head are scheduled in advance in the set. This allows to appropriately cope with the movement of the radio stations and the fault of communication conditions that are specific to the radio ad-hoc communication.

Further, according to the embodiment, before changing the cluster head in order, the time and period to configure the cluster as a cluster head are confirmed mutually with individual constitutive radio stations (nodes), in order to perform a change in synchronization. Accordingly, each radio station is determined at any stage whether it should operate as a cluster head or of which cluster head it should operate as a cluster member, thus even if a radio station occurs in the course of change that can not function as the cluster head or a cluster head is formed that has the unconnectable cluster members, an automatic recovery is performed within a predetermined time. This mechanism for change of cluster head is employed not only when circulating the cluster head to search for an optimal cluster head, but also when returning to the original cluster configuration for evaluation after searching or when delegating the cluster head to an optimal cluster.

As described above, the Bluetooth needs a process called Inquiry for searching for radio stations at the beginning of communication and a process called Page for connecting to a slave station, wherein a standard process needs a long time. However, according to the embodiment of the present invention, the Inquiry process is unnecessary by distributing information about radio stations belonging to the cluster to each radio station before reconfiguration, furthermore, the time necessary for the Page process is dramatically reduced to about 20 ms. Therefore, the cluster reconfiguration becomes possible that is substantially impossible now, thereby improving the communication efficiency. In particular, as for the Bluetooth, small-sized clusters are formed overlapped, whereby the interference of radio waves may occur. Therefore, the overhead becomes too large employing the conventional method wherein a cluster is formed after breaking up the once formed cluster and newly searching. However, according to the present invention, the cluster is reconfigured keeping the synchronization, thereby preventing the overhead.

In addition, as for the Bluetooth, one piconet (cluster) is composed of one master (cluster head) and up to seven active slaves (cluster members), thus the maximum number of members in the cluster is limited to eight, which is a stricter constraint than general ad-hoc networks. That is, as a piconet can treat only up to eight radio stations, therefore, when more than eight radio stations exist, even if all stations are within a coverage of radio waves, there is needed a configuration to connect a plurality of piconets by a bridge. However, applying the present invention, it is possible to reconfigure the cluster dynamically when two piconets may be merged due to a decrease of radio stations, for example, which means the present invention is also applied to division and merge of a plurality of piconets, that is, very effective for implementing the ad-hoc network for the Bluetooth.

As mentioned above, according to the present invention, it becomes possible to detect inappropriate conditions of the cluster head and re-select a better cluster head.

1. A communication method for a group communication, the method forming a predetermined cluster among a plurality of radio stations and selecting a cluster head managing the cluster, comprising the steps of:
operating one of the radio stations belonging to the cluster as a tentative cluster head;
determining the communication efficiency when the radio station becomes the tentative cluster head; and
selecting a cluster head in the cluster among the radio stations composing the cluster based on the determined communication efficiency.

2. The communication method according to claim 1, wherein the group communication is performed in a radio ad-hoc network of the master-slave configuration, wherein direct inter-slave communications are impossible.

3. The communication method according to claim 1, further comprising the steps of:
generating a schedule that determines an operation for circulating the radio stations as a tentative cluster head and an operation for the rest of each radio station composing the cluster to try to connect to the tentative cluster head; and
operating the radio stations composing the cluster synchronously based on the generated schedule.

4. The communication method according to claim 1, further comprising the steps of:
determining an operation to return to an original cluster configuration after operating as the tentative cluster head and a recover operation when being unable to return to the original cluster configuration as a recovery schedule in advance; and
operating the radio stations composing the cluster synchronously based on the recovery schedule.

5. A radio ad-hoc network composing a cluster that is composed of a node of a cluster head and one or more nodes of cluster members, wherein
the node of the cluster head comprehends its own communication conditions with the nodes of the cluster members and generates a schedule for change of the cluster head based on the communication conditions and distributes the schedule to the nodes of the cluster members; and
the nodes of the cluster members comprehend their own communication conditions with the nodes composing the cluster based on the distributed schedule and send the communication conditions to the node of the cluster head.

6. The radio ad-hoc network according to claim 5, wherein the node of the cluster head determines whether or not to delegate its authority as a cluster head based on the communication conditions sent from the nodes of the cluster members; and if affirmative, tries to delegate its authority to appropriate nodes.

7. The radio ad-hoc network according to claim 6, wherein the node of the cluster head determines the time to return to an original cluster configuration where it continues to serve as a cluster head when failing to delegate its authority to the appropriate nodes.

8. A radio ad-hoc network composing a cluster that is composed of a node of a cluster head and one or more nodes of cluster members, wherein
the cluster head distributes a schedule that determines a circulation operation of a tentative cluster head on the cluster members that compose the cluster; and
the cluster members comprehend as a tentative cluster head their communication conditions with other nodes based on the distributed schedule and sends the communication conditions to the cluster head, wherein the cluster members can become a new cluster head based on the delegation of authority from the cluster head.

9. The radio ad-hoc network according to claim 8, wherein the cluster head distributes the schedule that determines the circulation operation immediately after configuring the cluster or when a node with a high error rate is detected.

10. A communication terminal that can be configured as one of a plurality of nodes composing a cluster as well as serve as a cluster head that allows communication with remaining nodes of cluster members, comprising:
means for comprehending communication conditions with the cluster members;
means for recognizing communication conditions with other nodes when the cluster member becomes a tentative cluster head; and
means for determining the delegation of cluster head to a specific node based on the comprehended communication conditions and the recognized communication conditions.

11. The communication terminal according to claim 10, wherein the means for comprehending communication conditions comprehends the communication conditions by sending test data to each cluster member and detecting a packet error rate.

12. The communication terminal according to claim 10, further comprising:
means for creating a schedule for circulating the cluster members in order as a tentative cluster head; and
means for distributing the created schedule to the cluster members.

13. The communication terminal according to claim 12, wherein the schedule determines time for circulating a tentative cluster head among the nodes to search for an appropriate cluster head candidate; time for each node to try to connect to the tentative cluster head; and a period for which the reconnection is to be repeated if the tried connection failed.

14. The communication terminal according to claim 12, wherein the means for creating a schedule creates the schedule when the means for comprehending communication conditions determines that there is a trouble with the communication conditions.

15. A communication terminal that can be configured as one of a plurality of nodes composing a cluster as well as serve as a cluster member that allows communication with other nodes of cluster head, comprising:
means for receiving a circulation schedule to determine an aptitude degree as a cluster head from the cluster head;
means for comprehending communication conditions with other nodes composing the cluster based on the received circulation schedule; and
means for sending the comprehended communication conditions to the cluster head.

16. A Bluetooth terminal that can be configured as one of a plurality of radio stations composing a piconet as well as manage a plurality of slaves as a master, comprising:
means for comprehending communication conditions with the plurality Of slaves; and
means for delegating authority as a master to a predetermined slave composing the piconet to reconfigure the piconet if it is determined to be inappropriate as a master from the comprehended communication conditions.

17. The Bluetooth terminal according to claim 16, further comprising:
means for creating a schedule for circulating the plurality of slaves composing the piconet in order as a tentative master; and
means for distributing the created schedule to the plurality of slaves.

18. The Bluetooth terminal according to claim 17, further comprising:
means for receiving communication conditions with other radio stations when circulating the plurality of slaves as a tentative master; and
means for determining to delegate authority as a master to the predetermined slave based on the received communication conditions.
